(19) United States
(12) Patent Application Publication
(10) Pub. No.: US 2013/0234668 A1
(43) Pub. Date: Sep. 12, 2013

(54) UNIVERSAL SERIAL BUS APPARATUS AND POWER SUPPLY METHOD THEREOF

(71) Applicants: Li-Feng Kuo, New Taipei City (TW); Pao-Shun Tseng, New Taipei City (TW); Chun-Wei Chang, New Taipei City (TW)

(72) Inventors: Li-Feng Kuo, New Taipei City (TW); Pao-Shun Tseng, New Taipei City (TW); Chun-Wei Chang, New Taipei City (TW)

(73) Assignee: ASMedia Technology Inc., New Taipei City (TW)

(21) Appl. No.: 13/781,781

(22) Filed: Mar. 1, 2013

(30) Foreign Application Priority Data
Mar. 12, 2012 (CN) 201210063693.X

(51) Int. Cl. H02J 7/00

(52) U.S. Cl. CPC H02J 7/0052
USPC 320/125

(57) ABSTRACT

A power supply method for an universal serial bus apparatus is provided. The USB apparatus includes an upstream port module and a plurality of downstream port modules. The power supply method comprises the following steps: setting a maximum charging port number for the downstream port modules according to the connection configuration between the upstream port module and a host, and the condition of power supply from an external power supply; detecting the coupling condition of the electronic apparatuses to the downstream port modules so as to customize a specific charging specification for one of the electronic apparatuses; respectively providing a plurality of power to the electronic apparatuses according to the specific charging specification and the maximum charging port number. Thus, the electronic apparatuses enable to be charged with maximum charging currents and operate normally under the USB specification without being affected.

### CROSS-REFERENCE TO RELATED APPLICATION

This application claims the priority benefit of China application serial no. 201210063693.X, filed on Mar. 12, 2012. The entirety of the above-mentioned patent application is hereby incorporated by reference herein and made a part of this specification.

### BACKGROUND OF THE INVENTION

1. Field of the Invention

The disclosure relates to an electronic apparatus and a power supply method thereof, and more particularly, relates to an universal serial bus apparatus capable of dynamically charging the electronic apparatuses with different charging specifications.

2. Description of Related Art

As the technology advances, increasing types and functions of the portable electronic apparatuses, such as Smart Phone, Notebook, Tablet PC, Personal Digital Assistant (PDA), as well as MP3 and the like, become currently available. In order to satisfy general consumer demands, electronic apparatus trends towards the design direction of having a larger display and supporting variety of wireless functions (for example, concurrently supporting the transmission standards of Wi-Fi, 3G, LTE or the like). Along with the performance improvements, the inevitable accompaniment is the increment of power consumption. Therefore, in addition to enhance the capacity of the battery, attaining fast charging is also a major topic relating to the current product design.

Currently, the use of Universal Series Bus (USB) interface for power charging has been very popular. However, general apparatus may only draw a data transmission current of approximately 500 mA by charging through the USB interface, hence resulting a relatively long charging time. Therefore, the fast charging specifications capable of high current draw, such as the USB charging specification formulated by USB Inventor's Forum, Inc. (USB-IF) and the APPLE charging specification formulated by Apple Inc., enabling the electronic apparatus to draw a charging current of approximately 1500 mA for fast charging, have thus been formulated.

USB apparatus on the market, taking USB Hub for example, apart from being the relay expansion interface for communicating data transmission between the host and the multiple electronic apparatuses, mostly further possessing the function of charging the electronic apparatuses using the host or the external power supply. Moreover, many manufacturers have also developed the USB apparatus to be in compliance with various charging specifications for fast charging the electronic apparatus of different charging specification.

However, conventional USB apparatus on the market, which is capable of power charging, usually is designed with a fixed number of downstream ports as the charging ports corresponded to the specific charging specifications. When the electronic apparatus is not in compliance with the corresponding charging specification of the downstream port, or is coupled to the downstream port that is not designed to be the charging port, the fast charging is unfeasible. Therefore, when using the USB apparatus to fast charge a number of electronic apparatuses of different charging specifications, users may still encounter many inconveniences due to incompatibility.

### SUMMARY OF THE INVENTION

The disclosure provides a power supply method for an universal serial bus (USB) apparatus. The USB apparatus comprises an upstream port module and a plurality of downstream port modules. The power supply method comprises the following steps: setting a maximum charging port number for the downstream port modules according to the connection configuration between the upstream port module and a host, and the condition of power supply from an external power supply; detecting the coupling condition of a plurality of electronic apparatuses respectively coupled to the downstream port modules so as to customize a specific charging specification for one of the electronic apparatuses; and respectively providing a plurality of power sources to the electronic apparatuses according to the specific charging specification and the maximum charging port number.

In an exemplary embodiment, each of the downstream port modules respectively comprise a power supply switch and a bus voltage, wherein setting the maximum charging port number of the downstream port modules comprises the following steps: turning off the power supply switches of the downstream port modules; obtaining the maximum charging port number for the downstream port modules; and turning on the power supply switches corresponding to the downstream port modules according to the maximum charging port number.

In an exemplary embodiment, configuring the downstream port modules further comprises the following step: when the downstream port modules are respectively predetermined disabling from supplying power to the electronic apparatuses, setting the maximum charging port number to 0.

In an exemplary embodiment, determining the maximum charging port number comprises the following steps: when the upstream port module is not coupled to the host and the external power supply is not provided, setting the maximum charging port number to 0; when the upstream port module is coupled to the host and the external power supply is not provided, setting the maximum charging port number to 1 or 0 depending on whether the upstream port module receives a fast charging enabling information from the host; and, when the external power supply is provided, setting the maximum charging port number to a total amount of the electronic apparatuses coupled to the downstream port modules that may be provided with a fast charging current by the external power supply.

In an exemplary embodiment, each of the maximum charging port number for the downstream port modules is being reconfigured when the connection configuration between the upstream port module and the host, and the condition of power supply from an external power supply, are changed.

In an exemplary embodiment, customizing the specific charging specification that is in compliance with one of the electronic apparatuses and has a maximum power supply current, comprises the following steps: when the electronic apparatus is coupled to one of the downstream port modules, detecting a bus specification signal emitted by the electronic apparatus; analyzing whether the bus specification signal includes the charging request signal, so as to determine a first charging specification or a second charging specification for the electronic apparatus.

In an exemplary embodiment, the first charging specification is that the electronic apparatus takes initiative to emit out the fast charging request to a USB hub, and then the USB hub replies whether it is permitted to install a fast charging specification. The second charging specification is that the USB hub automatically permits the fast charging specification for the electronic apparatus.

In an exemplary embodiment, after determined the specification for the electronic apparatus is the first charging specification, it further comprises the following steps: determining whether a powered port number is less than the maximum charging port number; emitting the charging response signal when the powered port number is less than the maximum charging port number; and increasing the powered port number.

In an exemplary embodiment, the power supply method further comprises the following steps: when the bus specification signal is analyzed as not including a charging request signal, further determining whether the upstream port module is coupled to the host, or whether the host is in a suspend mode; and if complies with any of the two, then determining the charging specification for the electronic apparatus as the second charging specification.

In an exemplary embodiment, after determined the specification of the electronic apparatus is the second charging specification, it further comprises the following steps: determining whether a powered port number is less than the maximum charging port number; determining whether the second charging specification is in a voltage divider mode or in a software mode when the powered port number is less than the maximum charging port number; and increasing the powered port number.

In an exemplary embodiment, the voltage divider mode or the software of the second charging specification is the default charging mode pre-customized for the user. Under the voltage divider mode, the notification of the fast charging information is attained through electrical signal; under the software mode, the notification of the fast charging information is attained through data packet with USB specification.

In an exemplary embodiment, determining the second charging specification is in the voltage divider mode for executing a voltage dividing process comprises the following steps: turning off the power supply switches of the downstream port modules coupled to the electronic apparatuses; configuring a first data line and a second data line coupled to the downstream port module as a first default voltage and a second default voltage; turning on the power supply switches of the downstream port modules coupled to the electronic apparatuses; and removing voltages of the first data line and the second data line that are coupled to the downstream port module.

In an exemplary embodiment, determining the second charging specification is in the software mode for executing a software process comprises the following steps: turning off the power supply switches of the downstream port modules coupled to the electronic apparatuses; transmitting a fast charging enabling data packet to the electronic apparatuses through a first data line and a second data line that are coupled to the downstream port modules; and turning on the power supply switches of the downstream port modules coupled to the electronic apparatuses.

In an exemplary embodiment, the power supply method further comprises the following steps: determining whether the host is converted from the suspend mode to a data transfer mode; detecting whether the charging specification for the electronic apparatuses coupled to the downstream port modules is the second charging specification when the host is converted from the suspend mode to the data transfer mode; turning off the power supply switches of the downstream port modules coupled to the electronic apparatuses when the charging specification for the coupled electronic apparatuses is the second charging specification; reducing the powered port number; and turning on the power supply switches of the downstream port modules coupled to the electronic apparatuses, so as to recover the coupled electronic apparatuses back into the data transfer mode, which is in compliance with the USB specification, while not affecting normal USB transmission.

The disclosure provides an universal serial bus apparatus, comprising an upstream port module, a plurality of downstream port modules, an external power supply module, and a control module. The upstream port module is coupled to a host. The downstream port modules are respectively coupled in correspondence with a plurality of electronic apparatuses. The external power supply module is coupled to an external power supply. The control module is coupled to the upstream port module, the downstream port modules and the external power supply module. Wherein, the control module set a maximum charging port number for the downstream port modules according to a connection configuration between the upstream port module and the host, and a condition of power supply from the external power supply; detect the coupling condition of the electronic apparatuses to the downstream port modules in order to customize a specific charging specification for the electronic apparatuses; and respectively provide a plurality of power sources to the electronic apparatuses according to the specific charging specification and the maximum charging port number.

In an exemplary embodiment, the downstream port module comprises a power supply switch. The power supply switch controls and provides a bus voltage to the coupled electronic apparatus.

Based on the above, the embodiment of the disclosure detects the electronic apparatus coupled to the downstream port module, and dynamically determine and select the specific charging specification in compliance with the electronic apparatus, according to the connection configuration and the charging specification, so as to provide a maximum power supply current to the electronic apparatus under a permissible state, while not violating the USB specification.

The abovementioned features and advantages of the disclosure will become more obvious and better understood with regard to the following description of the exemplary embodiments and accompanying drawings in the below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic diagram for the USB apparatus in accordance with an exemplary embodiment.

FIG. 2 is a step flow chart diagram for the power supply method of the USB apparatus in accordance with an exemplary embodiment.

FIG. 3 is a step flow chart diagram for configuring the downstream port modules according to an exemplary embodiment.

FIG. 4 is a step flow chart diagram for the power supply method of the USB apparatus in accordance with an alternative exemplary embodiment.

FIG. 5 is a step flow chart diagram for performing the software process according to an exemplary embodiment.

FIG. 6 is a step flow chart diagram for performing the voltage dividing process according to an exemplary embodiment.

FIG. 7 is a step flow chart diagram for the power supply method when the upstream port module is converted from the suspend mode to the data transfer mode according to an exemplary embodiment.

### DESCRIPTION OF EMBODIMENTS

In the embodiments of an universal serial bus (USB) apparatus and of a power supply method, by detecting the connection configuration of an upstream port module, a plurality of downstream port modules and an external power supply module, and the condition of a power supply, to dynamically provide a fast charging information to a plurality of electronic apparatuses of different charging specifications, the electronic apparatuses are enabled to be charged with the maximum charging current. For a better understanding of the disclosed features, several exemplary embodiments are described in detail below as indeed the practical examples. In addition, it is possible that identical symbols in the figures and the embodiments are representing elements/components/steps of the same or similar parts.

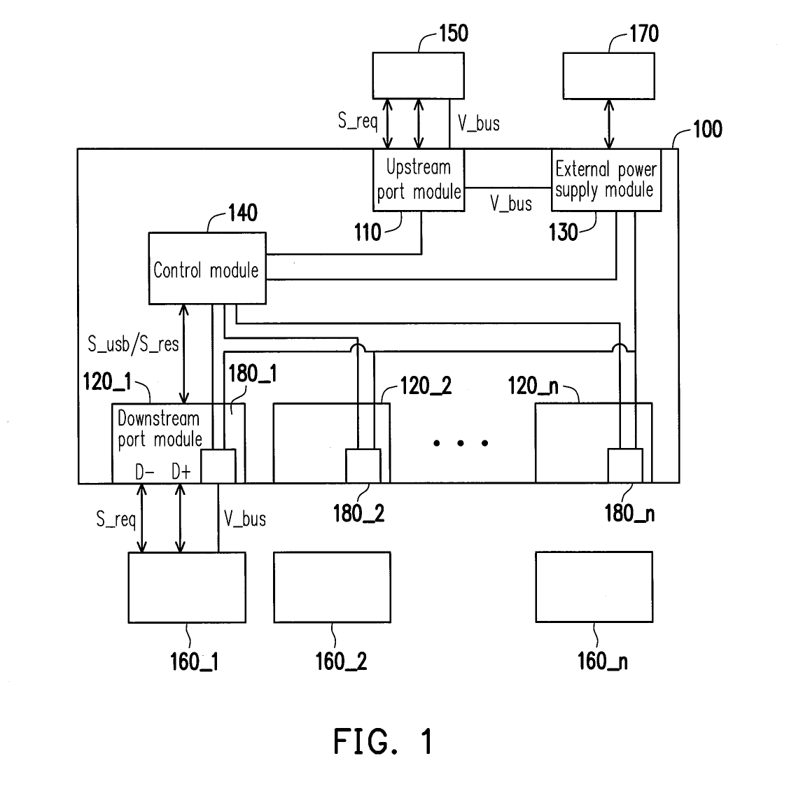

FIG. 1 is a schematic diagram for the USB apparatus in accordance with an exemplary embodiment. Referring to FIG. 1, the USB apparatus 100 comprises an upstream port module 110, a plurality of downstream port modules 120_1˜120_{—}n, an external power supply module 130, and a control module 140. Wherein, the upstream port module 110, the downstream port modules 120_1˜120_{—}n and the external power supply module 130 are all coupled to the control module 140.

In the embodiment, the upstream port module 110 may be used to couple a host 150. The downstream port modules 120_1˜120_{—}n may be coupled to the electronic apparatuses 160_1˜160_{—}n, respectively. The external power supply module 130 may be coupled to the external power supply 170. Wherein, the control module 140 determines a maximum charging port number of the downstream port modules 120_1˜120_{—}n according to the connection configuration between the upstream port module 110 and the host 150, and the condition of power supply from the external power supply 170, and also provides the fast charging possibility information for the electronic apparatuses 160_1˜160_{—}n according to the connection configuration of each of the downstream port modules 120_1˜120_{—}n, the charging specification for the electronic apparatuses 160_1˜160_{—}n, and the operation model of the host 150.

Specifically, the USB apparatus 100 is used as a relay expansion interface between the host 150 and the electronic apparatuses 160_1˜160_{—}n. Therefore the USB apparatus 100 can expand the connection port of the host 150 for coupling a variety of different electronic apparatuses 160_1˜160_{—}n, for example MP3, Tablet PC, Smart Phone or the like, in order to enable the host 150 or the external power supply 170 to perform data transmission or fast charging to the electronic apparatuses 160_1˜160_{—}n through the USB apparatus 100.

Conventional electronic apparatuses have different charging specifications, for instance the charging specification of the USB-IF and the charging specification of APPLE. Traditional USB apparatus generally design a fixed number of downstream ports to be the charging ports corresponded to the specific charging specifications; however, the embodiment of the USB apparatus 100 is to dynamically customize the corresponding charging specifications of the downstream port modules 120_1˜120_{—}n and the number of chargeable ports within the downstream port modules 120-1˜120_{—}n, thus increasing the compatibility and the convenience of the USB apparatus 100.

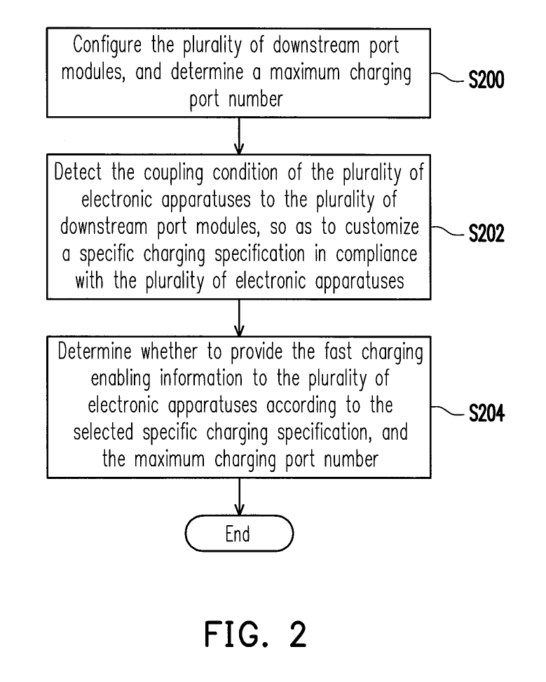

FIG. 2 is a step flow chart diagram for the power supply method of the USB apparatus in accordance with an exemplary embodiment. Referring to both FIG. 1 and FIG. 2, in the power supply method of the USB apparatus 100. In step 200, the control module 140 set a maximum charging port number for the downstream port modules 120_1˜120_{—}n according to the connection configuration between the upstream port module 110 and a host 150, and the condition of power supply from an external power supply 170.

In step S202, the control module 140 further detects the coupling condition of the electronic apparatuses 160_1˜160_{—}n to the downstream port modules 120_1˜120_{—}n, so as to customize a specific charging specification in compliance with the electronic apparatuses 160_1˜160_{—}n downstream port module.

In step S204, the control module 140 determines whether to provide the fast charging enabling information to the electronic apparatuses 160_1˜160_{—}n according to the selected specific charging specification through the connection configuration between the upstream port module 110 and the downstream port modules 120_1˜120_{—}n, the operational model of the host 150, and the maximum charging port number

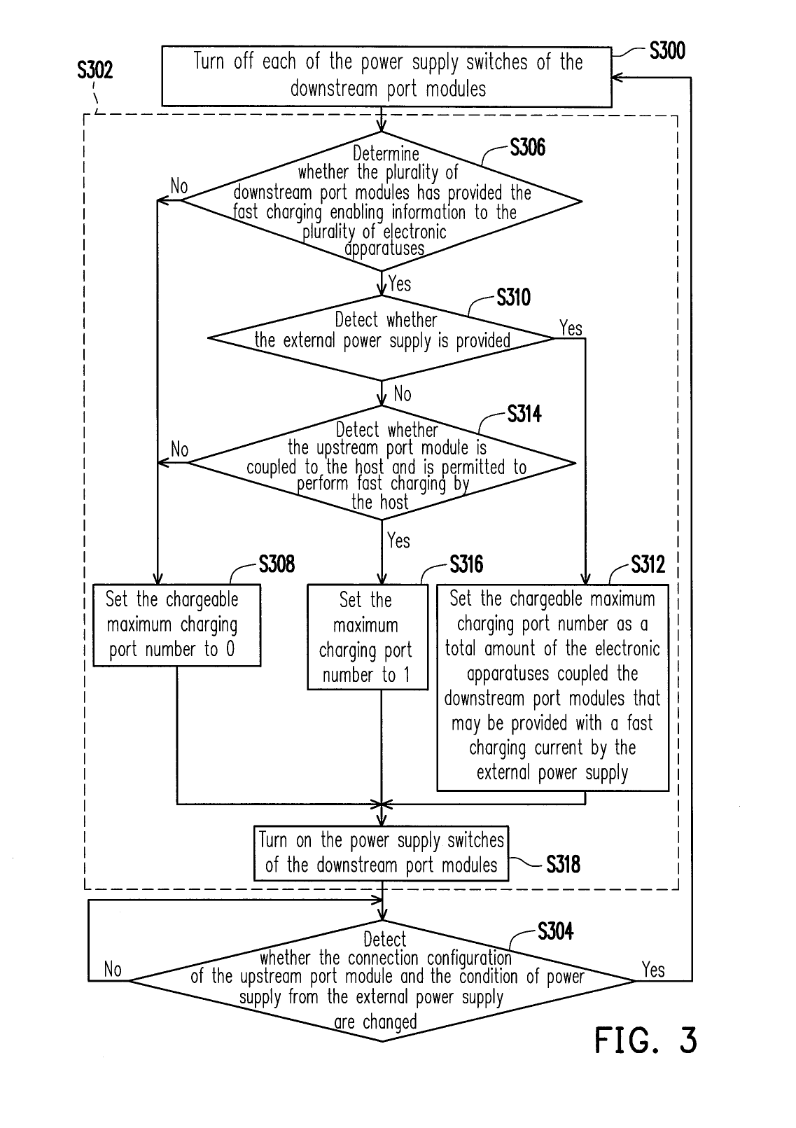

Specifically, each of the downstream port modules 120_1˜120_{—}n in FIG. 1 respectively includes a plurality of power supply switches 180_1˜180_{—}n for controlling whether the bus voltage V_bus is supplied to the coupled electronic apparatuses. The control module 140 for configuring the downstream port module 120_1˜120_{—}n, and determining the maximum charging port number in step S200 further comprises the steps shown in FIG. 3. FIG. 3 is a step flow chart diagram for configuring the downstream port modules according to an exemplary embodiment. Referring to FIG. 1 and FIG. 3, in the steps of configuring the downstream port modules 120_1˜120_{—}n. In step S300, the control module 140 turns off each of the power supply switches 180_1˜180_{—}n of the downstream port modules 120_1˜120_{—}n, for not supplying the bus voltage V_bus into each of the electronic apparatuses 160_1˜160_{—}n in order to initialized the state of each of the electronic apparatuses 160_1˜160_{—}n. In step S302, the control module 140 records the powered port number of the downstream port modules 120_1˜120_{—}n, wherein the powered port number is the number of downstream port modules that has provided the fast charging information to the electronic apparatus. Under the condition of not coupled to any electronic apparatus, the powered port number is set to 0. Next, the control module 140 determines the maximum charging port number according to the connection configuration between the upstream port module 110 and the host 150, and the condition of power supply from the external power supply 170.

In step S306 of step S302, the control module 140 determines whether the downstream port modules 120_1˜120_{—}n have provided the fast charging enabling information to the electronic apparatuses 160_1˜160_{—}n. Wherein, when the downstream port modules 120_1˜120_{—}n are determined as not fast charging enabled, the control module 140 sets the chargeable maximum charging port number to 0 in step S308. In other word, all the downstream port modules 120_1˜120_{—}n, at this moment, can only perform data transmission or use the data transmission current (500 mA in general), instead of the maximum power supply current (1500 mA in general), for charging.

After assured the downstream port module 120_1˜120_{—}n are enabled for charging, the control module 140 further detects the connection configuration of the external power supply module 130 for confirming the condition of power supply from the external power supply 170 in step S310. Under the condition when the control module 140 detects the external power supply 170 is coupled to the external power supply module 130, the control module 140 sets the chargeable maximum charging port number, wherein the maximum charging port number is a total amount of the electronic apparatuses coupled to the downstream port modules that can be provided with a fast charging current by the external power supply in step S312. In other word, all the downstream port modules 120_1˜120_{—}n are configured to be the chargeable charging ports, such that the external power supply 170 is able to charge each of the electronic apparatuses 160_1˜160_{—}n with the maximum power supply current, even when all the electronic apparatuses are concurrently coupled 160_1˜160_{—}n to the downstream port modules 120_1˜120_{—}n.

In step S314, when the external power supply 170 is not detected, the control module 140 further detects whether the upstream port module 110 is coupled to the host 150. Wherein, when the control module 140 detects the upstream port module 110 is not coupled to the host 150, the control module 140 sets the maximum charging port number to 0 in Step 308, because the USB apparatus 100 does not have a power source.

When the control module 140 detects the upstream port module 110 is coupled to the host 150, the control module 140 determines whether has the upstream port module 110 received the fast charging information emitted out by the host 150 for setting the maximum charging port number to 1 or 0 in step S316, such that when the host can only provide general charging, then at least one of the downstream port modules 120_1˜120_{—}n is configured to provide the maximum power supply current.

After the control module 140 set the maximum charging port number according to the above mentioned method, the control module 140 turns on the power supply switches 180_1˜180_{—}n of the downstream port modules 120_1˜120_{—}n in step S318, so as to enable each of the downstream port modules 120_1˜120_{—}n to provide power to the electronic apparatuses 160_1˜160_{—}n, thus initializing the electronic apparatuses 160_1˜160_{—}n.

In addition, after the maximum charging port number is determined, the control module 140 continuously detects whether the connection configuration of the upstream port module 110 and the condition of power supply from the external power supply 170 are changed in step S304. Once the control module 140 detects the connection configuration between the upstream port module 110 and the host 150, or between the external power supply module 130 and the external power supply 170, is changed, the control module 140 returns to step S300 to reconfigure the downstream port module 120_1˜120_{—}n. In other word, when any configuration of the power sources happens to be changed, such that the bus voltage V_bus is turned off, or the external power supply 170 is turned off, all the downstream port modules 120_1˜120_{—}n and the electronic apparatuses 160_1˜160_{—}n are to be reconfigured.

Incidentally, no sequential order is between the steps of detecting condition of power supply from the external power supply 170 in step S310 and of detecting connection configuration between the upstream port module 110 and the host 150 in step S314, such that it is possible to perform step S314 before performing step S310, the embodiment is not limited thereto.

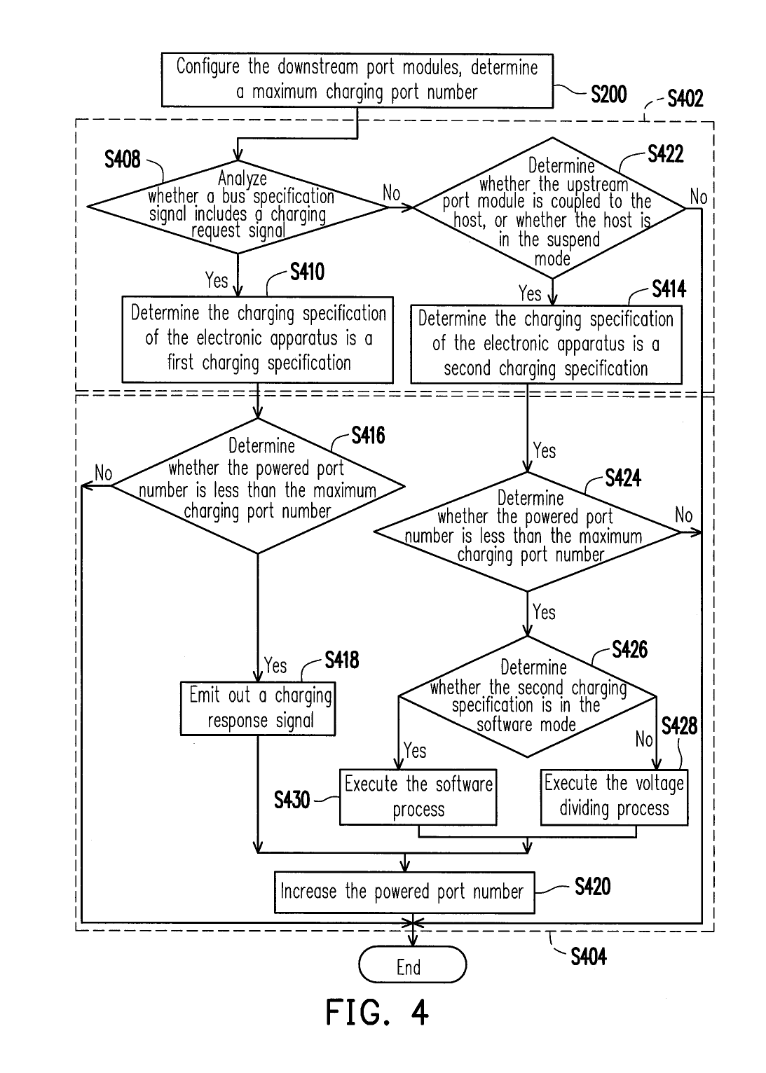

FIG. 4 is a step flow chart diagram for the power supply method of the USB apparatus in accordance with an alternative exemplary embodiment. Herein, in order to more clearly describe the power supply method for the USB apparatus. The embodiment uses the scenario of charging an electronic apparatus 160_1, which couples to a downstream port module 120_1, as an example to further disclose the power supply method of the current disclosure. However, the power supply method can also detect the charging specifications for each of the downstream port modules 120_1˜120_{—}n coupled to the electronic apparatuses 160_1˜160_{—}n, and dynamically configure whether the corresponding downstream port modules 120_1˜120_{—}n are the charging ports that respectively enabled to provide the maximum power supply current according to the charging specifications.

Referring to FIG. 1 and FIG. 4, after he plurality of downstream port modules 120_1˜120_{—}n is configured and the maximum charging port number is determined according to the embodiment shown in FIG. 3 and in step S200 of FIG. 4, the control module 140 detects whether the electronic apparatus 160_1 is coupled to the downstream port modules 120_1˜120_{—}n, in order to determine and select the specific charging specification in compliance with the electronic apparatus 160_1 in step S402.

In step S402, the control module 140, when the electronic apparatus is coupled to the downstream port module, detects whether a bus specification signal S_usb emitted out by the electronic apparatus 160_1 includes a charging request signal (step S408), when the bus specification signal S_usb includes the charging request signal, determines the charging specification for the electronic apparatus 160_1 is a first charging specification (step S410), such as the USB-IF charging specification, and when the bus specification signal S_usb does not includes the charging request signal, as well as not violating the USB specification under the condition of enabling the downstream port module to transmit a fast charging information to the electronic apparatus, determines the charging specification for the electronic apparatus 160_1 is a second charging specification (step S414), such as the APPLE charging specification.

Herein, to simplify the description and to provide the disclosure in a more complete manner, the embodiment describes the corresponding power supply method under the condition such that the charging specification for the electronic apparatus 160_1 respectively is a first charging specification and a second charging specification, wherein the first charging specification and the second charging specification are respectively referred to as the USB-IF charging specification and the APPLE charging specification for instance, but the embodiment is not limited hereto.

Referring to FIG. 1 and FIG. 4 again, the control module 140 does not configure the downstream port module 120_1 to be the maximum power supply current enabling charging port when the charging specification for the electronic apparatus 160_1 is not the USB-IF charging specification, and the host 150 is not in the suspend mode. In other word, the electronic apparatus 160_1, which is coupled to the downstream port module 120_1, is transmitting under the requirement of complying with the USB specification, and is only able to use the data transmission current for charging.

When the charging specification for the electronic apparatus 160_1 is the USB-IF charging specification, the control module 140 further determines whether the powered port number is less than the maximum charging port number (step S416). The control module 140 also does not configure the downstream port module 120_1 to be the maximum power supply current enabling charging port when the powered port number is determined to be equaled to the maximum charging port number. However, the electronic apparatus 160_1 is still able to use the current under the data transfer mode for charging.

When the control module 140 determines the powered port number is less than the maximum charging port number, the control module 140 emits out a charging response signal S_res to the electronic apparatus 160_1 (step S418), signaling the electronic apparatus 160_1 to draw the maximum power supply current from the host 150 or the external power supply 170, through the downstream port module 120_1, for charging. The control module 140, after the charging response signal S_res is emitted out to enable the charging of the electronic apparatus 160_1, increases the powered port number (step S420), and then performs the data transmission in compliance with the USB specification.

Contrarily, when the charging specification for the electronic apparatus 160_1 is not the USB-IF charging specification, the control module 140 determines whether the upstream port module 110 is coupled to the host 150, or whether the host 150 is in the suspend mode (step S422), and if so, then assumes the electronic apparatus 160_1 to be the APPLE charging specification. Wherein, if when the control module 140 detects the upstream port module 110 is coupled to the host 150 and the host 150 is in the data transfer mode, the electronic apparatus 160_1 is to use the general data transmission current for charging, and the control module 140 does not configure the downstream port module 120_1 to be the maximum power supply current enabling charging port.

When the control module 140 detects the upstream port module 110 is not coupled to the host 150, or the upstream port module 110 is coupled to the host 150 in the suspend mode, the control module 140 further determines whether the powered port number is less than the maximum charging port number (step S424), and if the powered port number is equal to the maximum charging port number, the control module 140 also does not configure the downstream port module 120_1 to be the maximum power supply current enabling charging.

When the control module 140 determines the powered port number is less than the maximum charging port number, the control module 140 further determines the charging specification for the electronic apparatus 160_1 is the APPLE charging specification in the voltage divider mode or in the software mode (step S426), thus executing the voltage dividing process (step S428) or executing the software process (step S430), and increases the powered port number after the electronic apparatus 160_1 is charged according to the voltage dividing process or the software process (step S420).

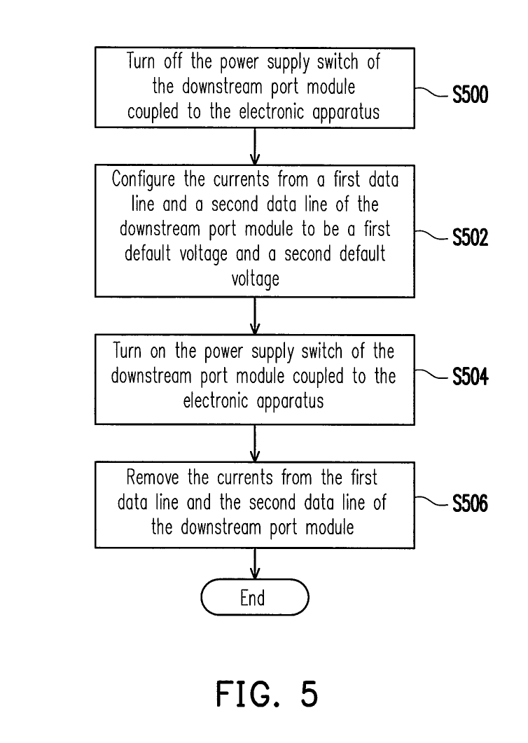

When the charging specification for the electronic apparatus 160_1 is determined as the APPLE charging specification in the voltage divider mode, the control module 140 executes the voltage dividing process steps, as shown in FIG. 5. FIG. 5 is a step flow chart diagram for performing the software process according to an exemplary embodiment. Referring to both FIG. 1 and FIG. 5, when executing the voltage dividing process, firstly, the control module 140 turns off the power supply switch 180_1 of the downstream port module 120_1 coupled to the electronic apparatus 160_1 (step S500).

Subsequently, the control module 140 configures the currents from a first data line D+ and a second data line D− of the downstream port module 120_1 to be a first default voltage (e.g., 2.8V) and a second default voltage (e.g., 2V) (step S502), and after waiting a period of time (approximately several milliseconds) for sustaining the first default voltage and the second default voltage, the control module 140 turns on the power supply switch 180_1 (step S504), while the electronic apparatus 160_1 is informed to be able to draw the maximum power supply current from the host 150 or the external power supply 170, according to the first default voltage on the first data line D+ and the second default voltage on the second data line D−, for charging. Moreover, after the charging begins, the currents from the first data line D+ and the second data line D− of the downstream port module 120_1 are removed (step S506).

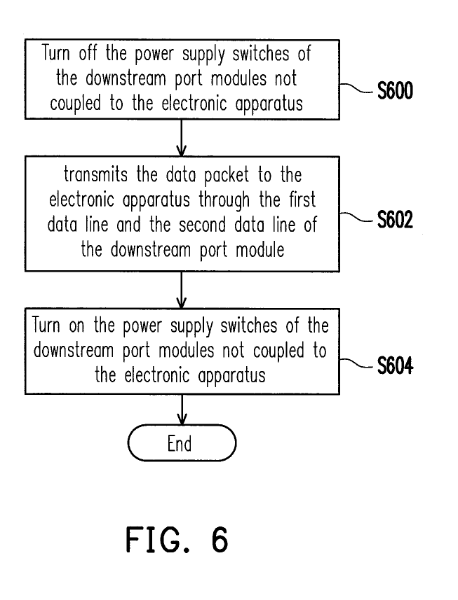

Contrarily, when the control module 140 determines the charging specification for the electronic apparatus 160_1 is the APPLE charging specification in the software mode, the control module 140 uses the method to transmit the fast charging enabling data packet to the electronic apparatus 160_1, so as to assure the electronic apparatus 160_1 is enabled to draw the maximum power supply current. The steps for executing the software process are shown in FIG. 6. FIG. 6 is a step flow chart diagram for performing the voltage dividing process according to an exemplary embodiment.

Referring to both FIG. 1 and FIG. 6, in order to avoid the interference from the other downstream port modules 120_2˜120_{—}n, firstly, the control module 140 turns off the power supply switches 180_2˜180_{—}n of the downstream port modules 120_2˜120_{—}n that are not coupled to the electronic apparatus in the software process (step S600). Next, the control module 140 transmits the data packet into the electronic apparatus 160_1 through the first data line D+ and the second data line D− of the downstream port module 120_1 (step S602).

When the fast charging enabling data packet is received, the electronic apparatus 160_1 is informed to be able to draw the maximum power supply current from the host 150 or the external power supply 170 for charging. Moreover, after the electronic apparatus 160_1 has started the charging, the control module 140 turns on the power supply switches 180_2˜180_{—}n again (step S604).

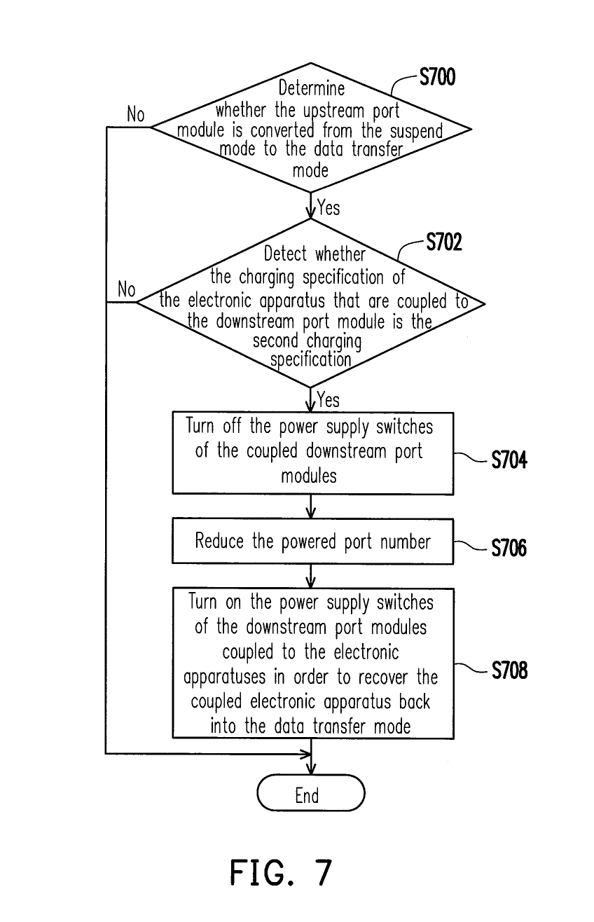

Herein, when the operational model of the host 150 is changed, the further disclosed power supply method of the USB 100 is as shown in FIG. 7. FIG. 7 is a step flow chart diagram for the power supply method when converting from the suspend mode to the data transfer mode according to an exemplary embodiment.

Referring to both FIG. 1 and FIG. 7, when the upstream port module 110 of the USB apparatus 100 is coupled to the host 150 in the suspend mode, and the electronic apparatus 160_1 is coupled to the downstream port module 120_1 for charging, the control module 140 detects and determines whether the host 150 is converted from the suspend mode to the data transfer mode (step S700). When the control module 140 determines the host 150 is converted from the suspend mode to the data transfer mode, the control module 140 further determines whether the charging specification for the electronic apparatus 160_1 is the APPLE charging specification (step S702); and when the control module 140 determines the electronic apparatus 160_1 is the APPLE charging specification, the control module 140 turns off the power supply switch 180_1(step S704) in order to stop the electronic apparatus 160_1 from drawing the maximum power supply current. Moreover, after the electronic apparatus 160_1 is stopped from charging, the control module 140 reduces the powered port number (step S706), and then turns on the power supply switch 180_1 of the downstream port module 120_1 in order to recover the electronic apparatus 160_1 that is coupled to the downstream port module 120_1 back into the data transfer mode (step S708), thus enabling the USB apparatus to provide a fast charging function without violating the USB specification.

Noteworthily, the mentioned functions in the control module 140, such as detection, recording, determination, and the likes can be achieved by using a plurality of different registers with the control unit of the firmware or the hardware developments in practical application, and the embodiment is not limited hereto.

In light of the foregoing, the embodiment of the disclosure detects the electronic apparatus coupled to the downstream port module, and dynamically determine and select the specific charging specification that is in compliance with the electronic apparatus according to the connection configuration and the charging specification in order to provide a maximum power supply current to the electronic apparatus, under a permissible state. Specifically, the power supply method can further optimizes the control of power supply for the electronic apparatus according to the operational model of the host, for instance the suspend mode or the data transfer mode. Whereby, the USB apparatus with high compatibility and having intelligent power supply control mechanism can thus be provided.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A power supply method for an universal serial bus apparatus that comprises an upstream port module and a plurality of downstream port modules, the power supply method comprising:
setting a maximum charging port number for the downstream port modules according to the connection configuration between the upstream port module and a host, and the condition of power supply from an external power supply;
detecting the coupling condition of a plurality of electronic apparatuses respectively coupled to the downstream port modules, so as to customize a specific charging specification for the electronic apparatuses; and
providing a plurality of power sources to the electronic apparatuses respectively according to the specific charging specification and the maximum charging port number.

2. The power supply method as claimed in claim 1, wherein each of the downstream port modules respectively comprises a power supply switch and a bus voltage, and setting the maximum charging port number of the downstream port modules, comprising the following steps:
turning off the power supply switches of the downstream port modules;
obtaining the maximum charging port number for the downstream port modules; and
turning on the power supply switches of the corresponding downstream port modules according to the maximum charging port number.

3. The power supply method as claimed in claim 2, obtaining the maximum charging port number of the downstream port modules, further comprising the following step:
setting the maximum charging port number to 0 when the downstream port modules are respectively predetermined disabling from supplying power to the electronic apparatuses.

4. The power supply method as claimed in claim 2, obtaining the maximum charging port number of the downstream port modules, further comprising the following steps:
when the upstream port module is not coupled to the host and the external power supply is not provided, setting the maximum charging port number to 0;
when the upstream port module is coupled to the host and the external power supply is not provided, setting the maximum charging port number to 1 or 0 depending on a fast charging enabling information from the host to the upstream port module; and
when the external power supply is provided, setting the maximum charging port number, wherein the maximum charging port number is a total amount of the electronic apparatuses coupled to the downstream port modules that can be provided with a fast charging current by the external power supply.

5. The power supply method as claimed in claim 1, further comprising:
resetting each of the maximum charging port number for the downstream port modules when the connection configuration between the upstream port module and the host, and the condition of power supply from an external power supply, are changed.

6. The power supply method as claimed in claim 1, customizing the specific charging specification for the electronic apparatuses, comprising the following steps:
detecting a bus specification signal emitted by one of the electronic apparatuses when the electronic apparatus is coupled to one of the downstream port modules, and analyzing whether the bus specification signal includes the charging request signal when the bus specification signal is received, for determining if the charging specification for the electronic apparatus is a first charging specification.

7. The power supply method as claimed in claim 6, after determined the specification of one of the electronic apparatuses is the first charging specification, further comprising the following steps:
determining whether a powered port number is less than the maximum charging port number;
emitting the charging response signal when the powered port number is less than the maximum charging port number; and
increasing the powered port number.

8. The power supply method as claimed in claim 6, when the bus specification signal is analyzed to not includes a charging request signal, further determining whether the upstream port module is coupled to the host, or whether the host is in a suspend mode, and if complies with any of the two, then the charging specification for one of the electronic apparatuses is the second charging specification.

9. The power supply method as claimed in claim 8, after determined the specification for one of the electronic apparatus is the second charging specification, further comprising the following steps:
determining whether a powered port number is less than the maximum charging port number;
when the powered port number is less than the maximum charging port number, pre-customizing the determined second charging specification into a voltage divider mode or a software mode; and
increasing the powered port number.

10. The power supply method as claimed in claim 9, determining the second charging specification is in the voltage divider mode for executing a voltage dividing process, comprising the following steps:
turning off the power supply switches of the downstream port modules coupled to the electronic apparatuses;
configuring a first data line and a second data line coupled to the downstream port modules as a first default voltage and a second default voltage;
turning on the power supply switches of the downstream port modules coupled to the electronic apparatuses; and
removing voltages of the first data line and the second data line coupled to the downstream port modules.

11. The power supply method as claimed in claim 9, determining the second charging specification is in the software mode for executing a software process, comprising the following steps:
turning off the power supply switches of the downstream port modules not coupled to the electronic apparatus;
transmitting a data packet to an electronic apparatus through a first data line and a second data line coupled to the downstream port module; and
turning on the power supply switches of the downstream port modules not coupled to the electronic apparatus.

12. The power supply method as claimed in claim 9, further comprising the following steps:
determining whether the host is converted from the suspend mode to a data transfer mode;
detecting whether the charging specification for the electronic apparatuses coupled to the downstream port modules is the second charging specification or not when the host is converted from the suspend mode to the data transfer mode;
turning off the power supply switches of the downstream port modules coupled to the electronic apparatuses when the charging specification for at least one of the coupled electronic apparatuses is the second charging specification;
reducing the powered port number; and
turning on the power supply switches of the downstream port modules coupled to the electronic apparatuses for recovering the coupled electronic apparatuses back into the data transfer mode.

13. An universal serial bus apparatus, comprising:
an upstream port module coupled to a host;
a plurality of downstream port modules, which is respectively coupled in correspondence with a plurality of electronic apparatuses;
an external power supply module coupled to an external power supply; and
a control module coupled to the upstream port module, the downstream port modules and the external power supply module;
wherein, the control module set a maximum charging port number for the downstream port modules according to a connection configuration between the upstream port module and the host, and a condition of power supply from the external power supply, detect the coupling condition of the electronic apparatuses to the downstream port modules to set a specific charging specification for the electronic apparatuses, and respectively provide a plurality of power sources to the electronic apparatuses according to the specific charging specification and the maximum charging port number.

14. The universal serial bus apparatus as claimed in claim 13, wherein each of the downstream port modules comprises:
a power supply switch, controlling and providing a bus voltage to the coupled electronic apparatus.
